(19) United States
(12) Patent Application Publication
(10) Pub. No.: US 2015/0281037 A1
(43) Pub. Date: Oct. 1, 2015

(54) MONITORING OMISSION SPECIFYING PROGRAM, MONITORING OMISSION SPECIFYING METHOD, AND MONITORING OMISSION SPECIFYING DEVICE

(71) Applicant: FUJITSU LIMITED, Kawasaki-shi (JP)

(72) Inventors: Shun Ishihara, Nagoya (JP); KOKI ARIGA, Nagakute (JP); Shinji Haseo, Toyoake (JP)

(21) Appl. No.: 14/668,255

(22) Filed: Mar. 25, 2015

(30) Foreign Application Priority Data
Mar. 31, 2014 (JP) 2014-071075

(51) Int. Cl. H04L 12/26

(52) U.S. Cl. CPC H04L 43/10; H04L 43/04

(57) ABSTRACT

Non-transitory computer-readable storage medium storing therein a monitoring omission specifying program for causing a computer to execute a process including: collecting log items respectively including generation time of events, which are transferred from a plurality of monitored devices to a first log item storage device, from the first log item storage device, and storing the collected log items in a second log item storage device, along with information on collection times; detecting a monitoring omission log item, of which a transfer delay to the first log item storage device has occurred, out of log items in the second log item storage device; and specifying, as a generation time of the transfer delay of the monitoring omission log item, a collection time of a log item generated by another monitored device and having a generation time close to the generation time of the monitoring omission log item.

### CROSS-REFERENCE TO RELATED APPLICATION

This application is based upon and claims the benefit of priority of the prior Japanese Patent Application No. 2014-071075, filed on Mar. 31, 2014, the entire contents of which are incorporated herein by reference.

### FIELD

The present invention relates to a monitoring omission specifying program, a monitoring omission specifying method, and a monitoring omission specifying device.

### BACKGROUND

Cloud computing includes Infrastructure as a Service (IaaS) that provides a virtual server and a network, and Platform as a Service (PaaS) that installs an OS and provides a database, in addition to providing a virtual server and a network. In either case, a user who uses cloud computing configures a service system of the user by a plurality of instances (including virtual machines, virtual devices, physical machines, physical devices or the like). The number of the instances that constitutes the service system often increases or decreases depending on the load and schedule of the service.

To monitor the service system, the user appropriately collects and manages log items outputted by each instance. The log items includes an event log of the service system and a performance information log which is sampled at a predetermined interval. The performance information log includes, for example, load values of the instance, such as a CPU use rate, a memory use amount, a network transfer amount and the number of events.

A method for unitarily managing these log items is a technique where each of a plurality of instances periodically transfers log items, generated in the respective instance, to a common log item storage device which integrates these log items, and a monitoring server periodically polls the log item storage device and collects the log items. The monitoring server monitors the state and abnormality of each instance in real-time based on the collected log items of each instance. As a database in the common log item storage device, a Key Value Store (KVS) type database is used because of its high-speed processing and good expandability.

Data collection is discussed in Japanese Patent Application Laid-open No. 2013-73497 and Japanese Patent Application Laid-open No. 2005-115724.

### SUMMARY

In some cases however, each instance is not able to transfer the log items to the database due to load concentration, for example. In this case, the monitoring server is unable to collect the log items from the log item storage device, and omission of a log item is generated. If such an omission of a log item is generated, the monitoring server is unable to appropriately monitor the cloud service system.

Furthermore, each log item includes the generated time of the log item and the content (event) of the log item, but does not include the transfer time from the instance to the log item storage device. Therefore if a monitoring omission is generated because of the omission of a log item, the time when the monitoring omission was generated, due to a transfer delay, is unable to be known.

One aspect of the embodiment is non-transitory computer-readable storage medium storing therein a monitoring omission specifying program for causing a computer to execute a process comprising:

collecting log items respectively including generation time of events, which are transferred from a plurality of monitored devices to a first log item storage device, from the first log item storage device, and storing the collected log items in a second log item storage device, along with information on collection times when the collected log items are collected;

detecting a monitoring omission log item, of which a transfer delay to the first log item storage device has occurred, out of log items in the second log item storage device; and

specifying, as a generation time of the transfer delay of the monitoring omission log item, a collection time of a log item generated by another monitored device, which is different from the monitored device that has generated the monitoring omission log item, and having a generation time close to the generation time of the monitoring omission log item.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting cloud computing for which the monitoring omission generation time is specified according to this embodiment.

FIG. 2 is a diagram depicting a log collection process by the monitoring server.

FIG. 3 is an example of a data configuration of a log of a KVS type database.

FIG. 4 is a diagram depicting an example of a first method to prevent monitoring omission.

FIG. 5 is a diagram depicting an example of a second method to prevent monitoring omission.

FIG. 6 is a diagram depicting the difficulty of accurately estimating the time block when a monitoring omission is generated, because the transfer time is unknown.

FIG. 7 is a diagram depicting a configuration of a monitoring server 30 according to the present embodiment.

FIG. 8 is a diagram depicting a configuration and process of the cloud computing center and the monitoring server according to the present embodiment.

FIG. 9 is a flow chart depicting an outline of the process of real-time log monitoring without generating a monitoring omission according to the present invention.

FIG. 10 is a flow chart depicting a monitoring omission generation time specifying process S1.

FIG. 11 is a diagram depicting the log collection by the monitoring server.

FIG. 12 is a diagram depicting the log collection by the monitoring server.

FIG. 13 is a flow chart depicting the process S16 that specifies the log having a generation time closest to the generation time of the monitoring omission log according to the present embodiment.

FIG. 14 is a table and a diagram respectively describing a method for estimating the log transfer interval of each instance.

FIG. 15 is a table and a diagram respectively describing a method for estimating the log transfer interval of each instance.

FIG. 16 is a diagram depicting an example of the logs of the instances B, C and E, which the monitoring server grouped as instances of which time differences are close.

FIG. 17 is a diagram depicting an example of the monitoring omission generation time specified in the monitoring omission generation time specifying process S1.

FIG. 18 is a flow chart depicting the monitoring omission pattern constructing process S2.

FIG. 19 is a diagram depicting an example of the monitoring omission pattern.

FIG. 20 is a flow chart depicting the sign detection of the monitoring omission generation and the individual polling process S3 in FIG. 9.

FIG. 21 is a diagram depicting the match between the monitoring omission pattern and the transition data of a load value currently being monitored in the sign detection of monitoring omission generation.

FIG. 22 is a diagram depicting the individual collection when the sign of monitoring omission generation is detected according to this embodiment.

### DESCRIPTION OF EMBODIMENTS

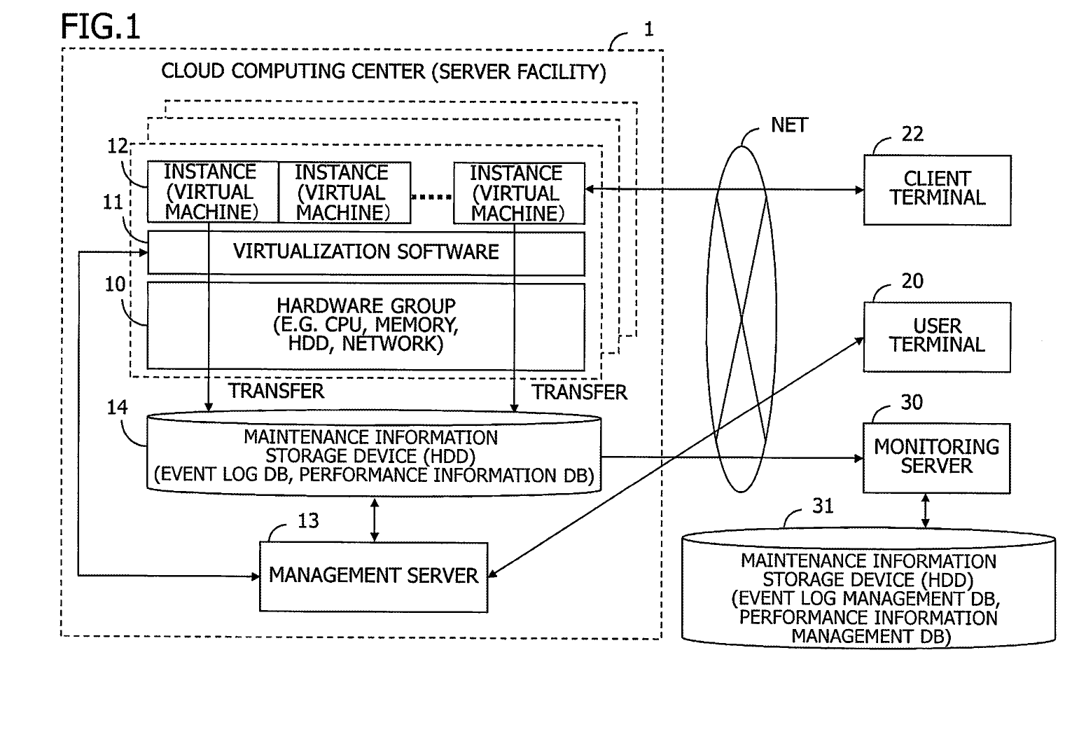

FIG. 1 is a diagram depicting cloud computing for which the monitoring omission generation time is specified according to this embodiment. In a cloud computing center 1, which is a service facility, a hardware group 10, a management server 13 and a large capacity maintenance information storage device (e.g. hard disk) 14 are disposed. The center 1 is enabled to be connected with a user terminal 20 of the cloud computing service, a client terminal 22 which accesses the service system of the user and which uses the service, a monitoring server 30 that monitors the service system of the user, and the like via a network NET (e.g. Internet, intranet).

The user accesses the management server 13 from the user terminal 20, initiates a contract to use the cloud computing service, and constructs a service system using virtual machines (hereafter also called “instances”) 12 that virtualizes a hardware group 10.

A client who uses the service system of the user accesses the virtual machines 12 constituting the service system from the client terminal 22 via the network NET to use the service.

The hardware group 10 includes a plurality of servers, and each server has a CPU, a memory (RAM), a large capacity storage device, (e.g. a hard disk (HDD)) and a network or the like. The user who uses the cloud computing service accesses the management server 13 from the user terminal 20, selects the specification needed to construct the service system of the user, and initiates a contract to use the cloud computing service.

For example, the user selects a specification of the virtual machine that is needed for the service system of the user, such as the clock frequency of the CPU, the capacity of the memory, the capacity of the hard disk, the bandwidth of the network, the OS, the database and the program language via input from the user terminal 20.

Then the management server 13 requests virtualization software (hypervisor) 11 of a host machine of the hardware group 10, to virtualize the hardware group 10, and allocate the virtual hardware group 10 to the virtual machines 12 based on the user contract so as to construct one or a plurality of virtual machine(s) 12 that constitute the service system of the user. The management server 13 also manages the operation state of the virtual machine 12 that constitutes the service system of the user in cooperation with the virtualization software 11. When load concentrates on a certain virtual machine 12, for example, the management server 13 requests the virtualization software 11 to scale out by generating new virtual machines. Therefore the number of virtual machines (called “instances” herein below) that constitute the service system increases/decreases frequently according to the load and work schedule.

To investigate the cause of failure of the service system of the user, the monitoring server 30 collects event logs, which the service system outputs at a predetermined frequency, and performance information logs sampled at a predetermined interval. The monitoring server 30 may be operated by the user, or may be operated by a third party consigned by the user.

The event log includes, for example, regular events, such as service start and service stop, and error events, such as startup failure, file access failure and file writing failure. The performance information log includes a CPU use rate, a memory use amount, the number of generated events and a network transfer amount, for example.

Generally the monitoring server 30 collects the event logs and the performance information logs as follows. First the plurality of instances 12 constituting the service system asynchronously transfers the event log generated in each instance and the performance information log sampled by each instance to a common database stored in the maintenance information storage device 14. Thereby the monitoring server 30 is enabled unitarily store and manage the logs in response to the increase/decrease of the instances which are generated and eliminated frequently.

The transfer interval, which is the transfer frequency, is set by the user for each instance when the user contract is initiated. Normally a short transfer interval, such as several minutes, is set for the event logs generated from an instance having high urgency, and a longer transfer interval is set for the event logs generated from an instance having a lower urgency. The performance information logs are set with a relatively long transfer interval.

For the event log database (DB) and the performance information log database (DB) in the maintenance information storage device 14, a KVS (Key Value Store) type database is used because of its high-speed processing and expandability.

Then the monitoring server 30 collects the latest log stored in the database in the maintenance information storage device 14 virtually in real-time, and stores the latest log in the event log management DB and in the performance information log management DB of the maintenance information storage device 31 of the monitoring server 30. Thereby the monitoring server 30 monitors abnormality of the instances of the service system in real-time.

In this embodiment, the monitoring server 30 collects logs from the maintenance information storage device 14, which stores logs transferred from virtual machines 12, and monitors the state of the virtual machines based on the collected logs. Here “log” refers to an individual log which is stored in the log file as a record, and may also be called a “log item” to distinguish it from a log file. The maintenance information storage device 14 is a log item storage device since individual log items are stored in a database that is stored in the maintenance information storage device 14. The maintenance information storage device 31 managed by the monitoring server 30 is also a log item storage device. In addition to virtual machines, the monitoring server 30 according to this embodiment also collects logs of a physical machine, a physical device installed in a physical machine, a virtual device installed in a virtual machine or the like, since these devices are also monitoring target devices. Therefore “instance” herein below refers to a monitored device, including a virtual machine, a virtual device, a physical machine and a physical device.

[Problem of Log Collection]

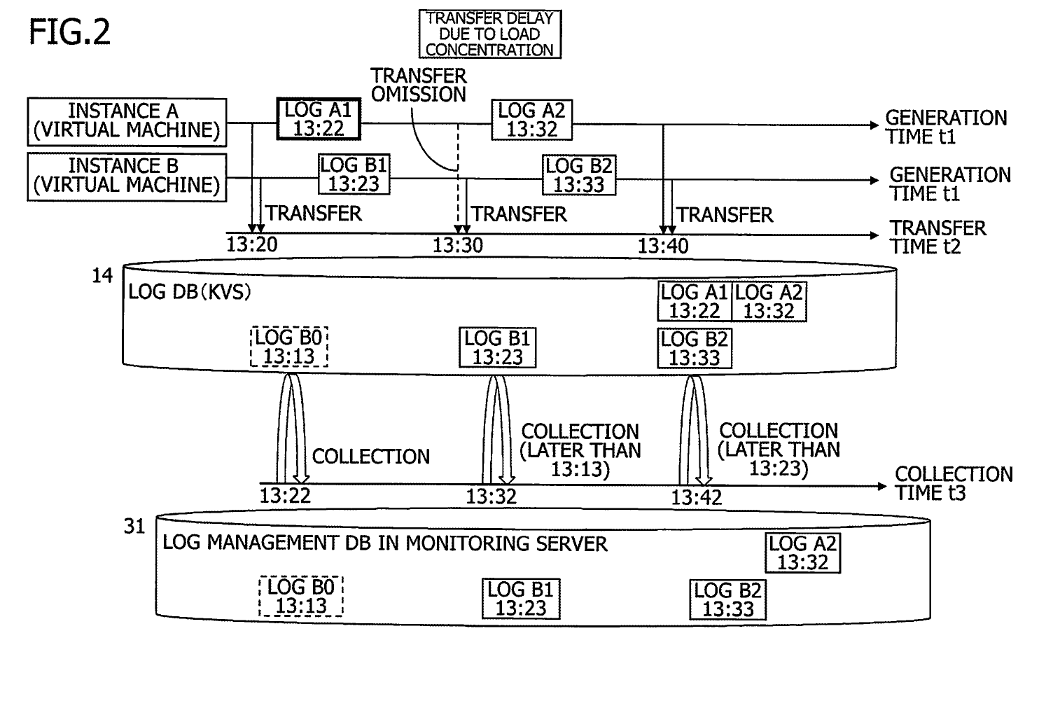

FIG. 2 is a diagram depicting a log collection process by the monitoring server. Firstly a plurality of instances A and B constituting the service system generate logs respectively. Time when each instance generates a log is called “generation time t1”. Each instance generates an event log and a performance information log. In the example in FIG. 2, the instance A generates a log A1 at generation time 13:22, and a log A2 at generation time 13:32 respectively. The instance B generates a log B1 at generation time 13:23, and a log B2 at generation time 13:33 respectively.

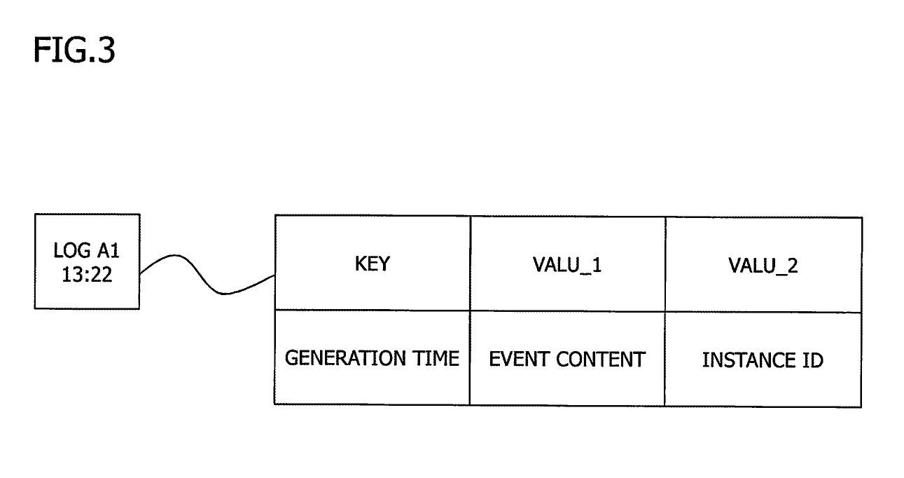

FIG. 3 is an example of a data configuration of a log of a KVS type database. The log A1 includes a generation time as KEY, and an event content (content of a generated event), an instance ID or the like, as VALU. In the case of this data configuration, a log can be extracted by using a generation time as a key, for example.

Secondly each instance A and B transfers the respective generated log to a log DB in the maintenance information storage device 14 in the cloud computing center at a transfer interval set in the user contract. Hereafter the time when the instance transfers a log item to the log DB in the maintenance information storage device 14 is called “transfer time t2”. In the case of FIG. 2, both the instances A and B transfer the generated logs at 13:20, 13:30 and 13:40 at ten minute transfer intervals.

Thirdly the monitoring server 30 periodically executes log collection polling and collects logs from the log DB in the maintenance information storage device 14. Time of the log collection by the monitoring server is called “collection time t3”. In the example in FIG. 2, the monitoring server 30 executes the polling of the log collection at the correction times 13:22, 13:32 and 13:42 at ten minute intervals. In this log collection, the monitoring server 30 collects logs having a generation time that is later than the latest generation time of the logs collected at a previous polling, using the generation time of the log as a key. The monitoring server 30, which is unable to know the transfer time of each instance, collects logs having a generation time that is later than the latest generation time of the logs collected the last time, so the collected logs do not overlap.

However in the case of the above mentioned log collection, a following problem occurs. Here it is assumed that only a specific instance was unable to transfer the logs to the log DB because of load concentration, and this transfer omission caused a transfer log delay until the next transfer opportunity. In the case of FIG. 2, the instance A did not transfer the log A1 at the transfer time 13:30 because of load concentration. In other words, the log A1 became a transfer omission log at the point of transfer time 13:30. However the monitoring server 30 repeats the periodic polling of log collection, and collects logs having a generation time that is later than the latest generation time of the previously collected logs in each log collection. As a result, in the collection at the collection time 13:32, the monitoring server collects the log B1 of the instance B, but is unable to collect the log A1 of the instance A, and is still unable to collect the log A1 even in the collection at the collection time 13:42, which is after the log A1 was transferred with delay at the transfer time 13:40, since the collection key is a generation time later than the generation time 13:13 of the log B1. In other words, the log A1 transferred with delay is not collected in the log collection thereafter. This uncollected log A1 is a monitoring omission log generated because transfer is omitted and is executed with delay, and the monitoring omission is generated by the generation of the monitoring omission log.

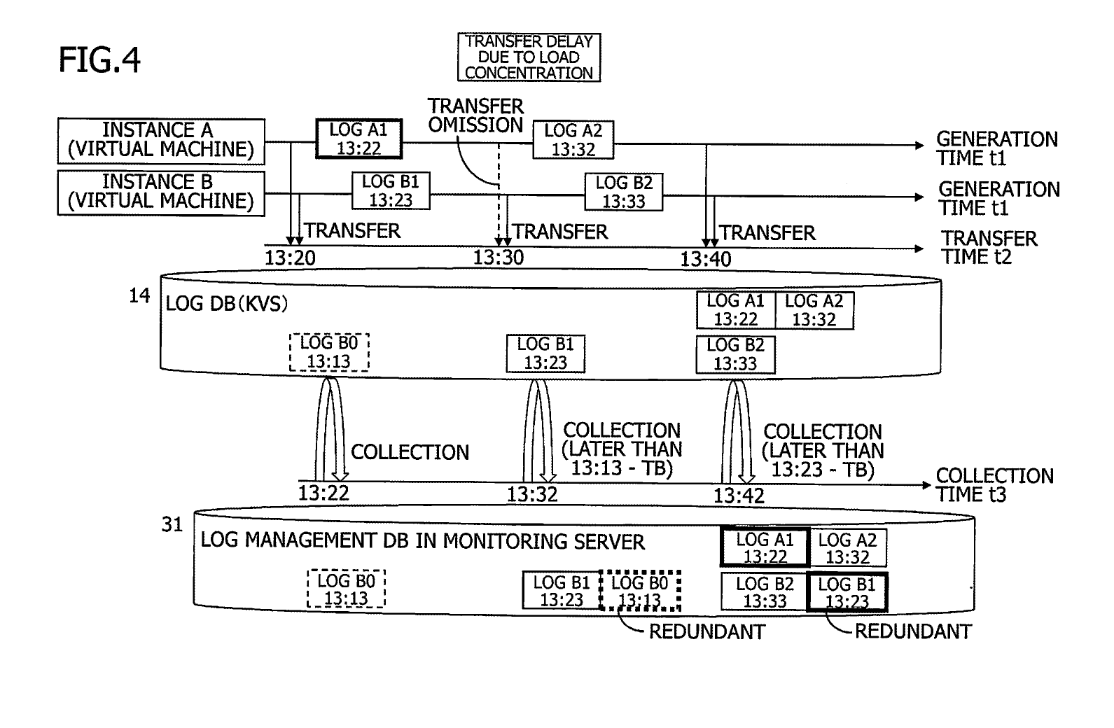

FIG. 4 is a diagram depicting an example of a first method to prevent monitoring omission. FIG. 4 illustrates the same example of generating and transferring logs as FIG. 2. According to the example of the first method to prevent the monitoring omission, the key to collect logs is a log having a generation time that is later than a time before the latest generation time of the previously collected logs by a predetermined rewind time TB, and the monitoring server collects extra logs generated in the past during each collection polling, and deletes redundant logs which were already collected.

According to this first method in FIG. 4, when logs are collected at the collection time 13:32, the monitoring server collects a log having a generation time that is later than time 13:13-TB, which is a time before the generation time 13:13 of the previously collected log B0 by the rewind time TB, hence the monitoring server collects the log B0 again in addition to the log B1. Therefore the monitoring server deletes the redundant log B0. When logs are collected at the collection time 13:42, the monitoring server collects a log having a generation time that is later than time 13:23-TB, which is a time before the generation time 13:23 of the log B1, by the rewind time TB, hence the monitoring server collects the logs A1, A2, B1 and B2. Therefore the monitoring server deletes the redundant log B1. Here the monitoring server can collect the log A1 of which transfer was delayed.

According to the first method, the collection omission decreases if the rewind time TB increases, but the number of redundantly collected logs increases and the communication traffic amount during collection increases. If the rewind time TB is shortened, the number of redundantly collected logs decreases, and the communication traffic amount also decreases, but the probability of collection omission increases. Further, the rewind time TB needs to be manually determined based on experience, and optimizing the rewind time TB is difficult since load on each instance differs depending on the day and time, and estimating the time and duration when a load concentration occurs is difficult.

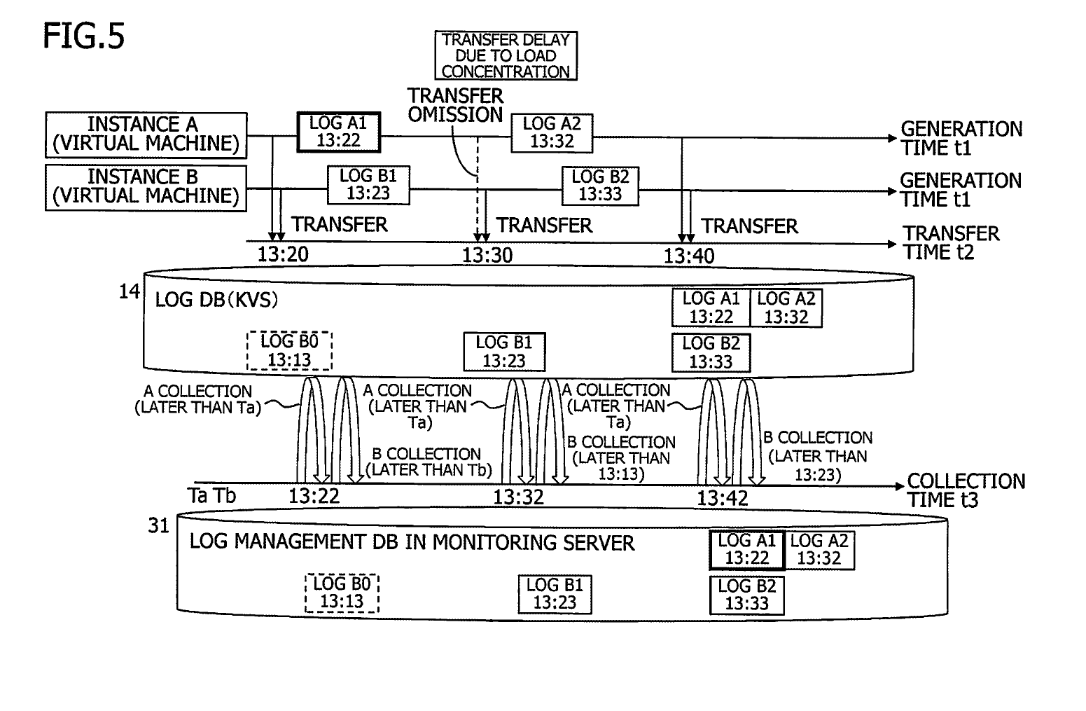

FIG. 5 is a diagram depicting an example of a second method to prevent monitoring omission. FIG. 5 illustrates the same example of generating and transferring logs as FIG. 2. According to the example of the second method to prevent the monitoring omission, the monitoring server executes polling to collect logs from the instances A and B individually. According to this individual collection, the monitoring server collects a log having a generation time later than the latest generation time of the previously collected logs, for each of the instances. Therefore a generation time of a key for collection is different for each instance.

In the example in FIG. 5, it is assumed that the latest generation time of the logs of the instances A and B were Ta and Tb respectively in the individual collection before the collection time 13:22. The monitoring server collects the log B0 in the individual collection at the collection time 13:22. Then in the individual collection at the collection time 13:32, the monitoring server collects a log of which generation time is later than the time Ta for the instance A, and collects a log of which generation time is later than the generation time 13:13 of the log B0 for the instance B respectively, that is collects the log B1. In this case, the instance A was unable to transfer the log A1 because of load concentration, hence the monitoring server is unable to collect the log A1 of which transfer delayed. In the individual collection at the collection time 13:42, the monitoring server again collects a log of which generation time is later than the time Ta for the instance A, and collects the log of which generation time is later than the generation time 13:23 of the log B1 for the instance B respectively. As a result, the monitoring server collects the log A1 of which transfer delayed, in addition to the log A2, in the individual collection for the instance A, and collects the log B2 in the individual collection for the instance B.

If the monitoring server individually collects logs for each instance like this, a log of which transfer delayed is enabled to be collected without fail. In the above example, the log A1 was transferred with delay, but was collected with certainty by the collection polling after the transfer. Therefore generation of the monitoring omission can be prevented.

However if the number of instances constituting the service system of the user becomes enormous, the number of pollings of the individual collection also becomes enormous, and load on the monitoring server increases. Therefore it is not preferable to execute polling of an individual collection all the time.

### Present Embodiment

In the present embodiment, the monitoring server analyzes a time block when transfer of a log tends to be omitted and a log bottleneck occurs, which causes monitoring omission, detects a sign of generation of the monitoring omission for each monitoring target instance of the service system, and executes polling of an individual collection for the instance where the sign is detected until the log bottleneck is cleared.

A problem of analyzing the time block when a monitoring omission is generated is that the transfer time of the logs is unable to be known. In other words, it is possible to specify a monitoring omission log by comparing the logs in the log management DB, which were already collected by the monitoring server, with the already transferred logs in the log DB in the maintenance information storage device 14. However the log transfer time at each instance is unknowable, which means that it is impossible to analyze the time block when load concentration was generated and log transfer was not executed, causing a delay in transfer of the log. As mentioned above, the user sets the transfer interval for each instance in the user contract. However the transfer time of a log is under management of the cloud computing service provider, which is information that is not needed to monitor the cloud computing service, so generally the monitoring server, operated by the user, is unable to acquire the transfer time.

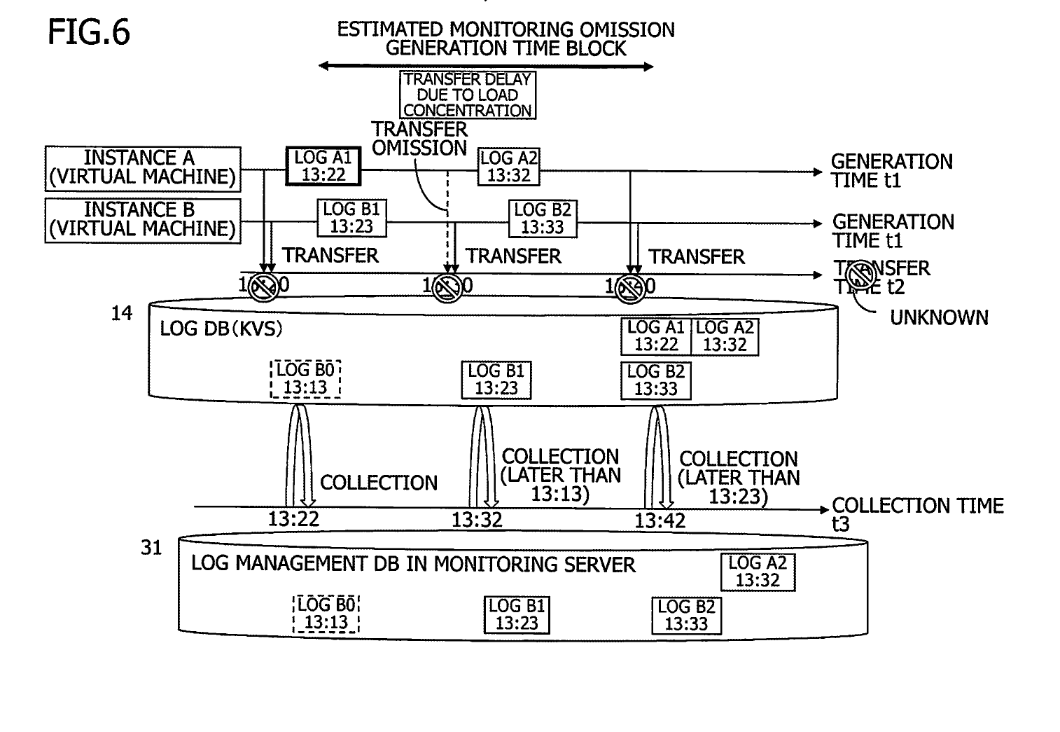

FIG. 6 is a diagram depicting the difficulty of accurately estimating the time block when a monitoring omission is generated, because the transfer time is unknown. The example of generation, transfer and collection of the logs in FIG. 6 is the same as FIG. 2.

As mentioned above, it is impossible to know the transfer time at each instance. Therefore it is assumed that the monitoring omission log A1 was detected by comparing the logs in the log DB in the maintenance information storage device 14 with the logs in the log management DB on the monitoring server side. The generation time of the log A1, which is needed as monitoring information, is included in the data of the log A1. However the transfer time at the instance A which generated the log A is unknown. Hence all that can be estimated is that the time block, when transfer omission that caused the monitoring omission of the log A1 was generated and the log bottleneck occurred due to the transfer delay, is at least before the collection time 13:42 and later than the generation time 13:22 of the log A1.

The estimated time block when the log bottleneck occurred, due to the transfer delay, is long, and executing the polling of the individual collection for the instance A for such a long time causes a heavy load on the monitoring server. If the log transfer time at the instance A were able to be known, then it can be correctly estimated that, for example, the transfer omission was generated at the transfer time 13:30 after the generation time of the monitoring omission log A1, and the transfer was restarted at the next transfer time 13:40. As a result, the polling of the individual collection can be executed for the instance A in a period from the transfer time 13:30 when the transfer omission was generated to the transfer time 13:40 when the transfer restarted, and the monitoring omission log A1 is able to be collected in a timely manner in the individual collection in the shortest time block 13:30-13:40.

Now an overview of the present embodiment will be described, next a method for specifying the time when the monitoring omission was generated due to a transfer omission will be described, and finally a method for collecting logs without a monitoring omission will be described.

[Overview]

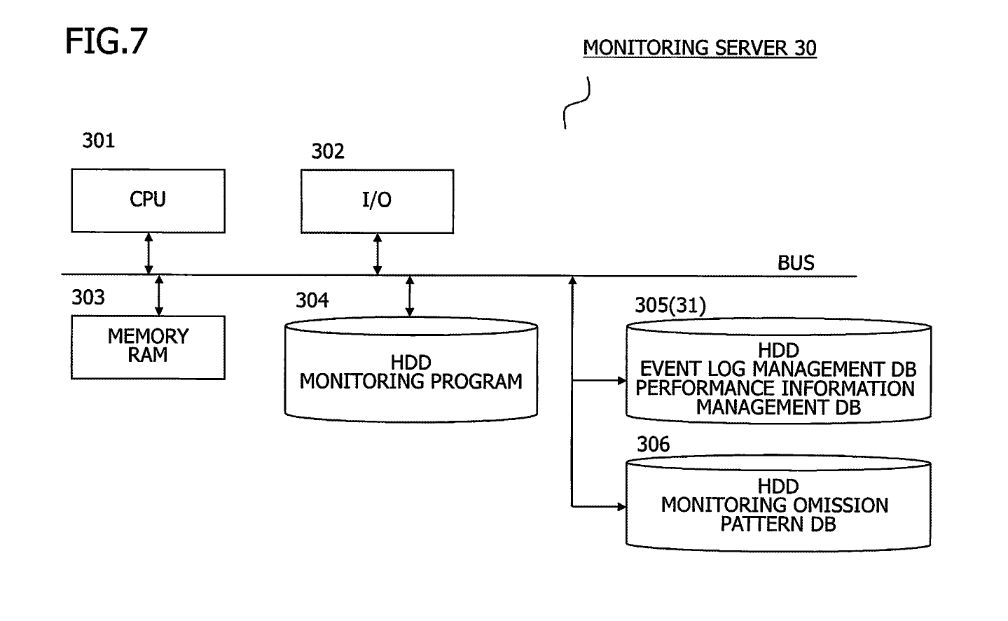

FIG. 7 is a diagram depicting a configuration of a monitoring server 30 according to the present embodiment. The monitoring server 30 includes a CPU 301, an input/output device 302, a main memory (RAM) 303, and a large capacity storage device (HDD). The large capacity storage device stores a monitoring program 304 to execute the monitoring of logs, an event log management DB and performance information management DB 305 (31) for collected logs, and a monitoring omission pattern DB 306. As the CPU 301 executes the monitoring program 304 developed in the memory 303, the monitoring server 30 collects the accumulated logs in the log DB in the maintenance information storage device 14 in the cloud computing service center 1, detects a monitoring omission log of which transfer was omitted and delayed, compiles a database of the performance information pattern before the transfer omission at the instance where the monitoring omission was generated, detects a sign of the monitoring omission generation due to the transfer omission at the instance of the service system being monitored, based on the transfer omission patterns, and executes the polling of an individual collection for the detected instance.

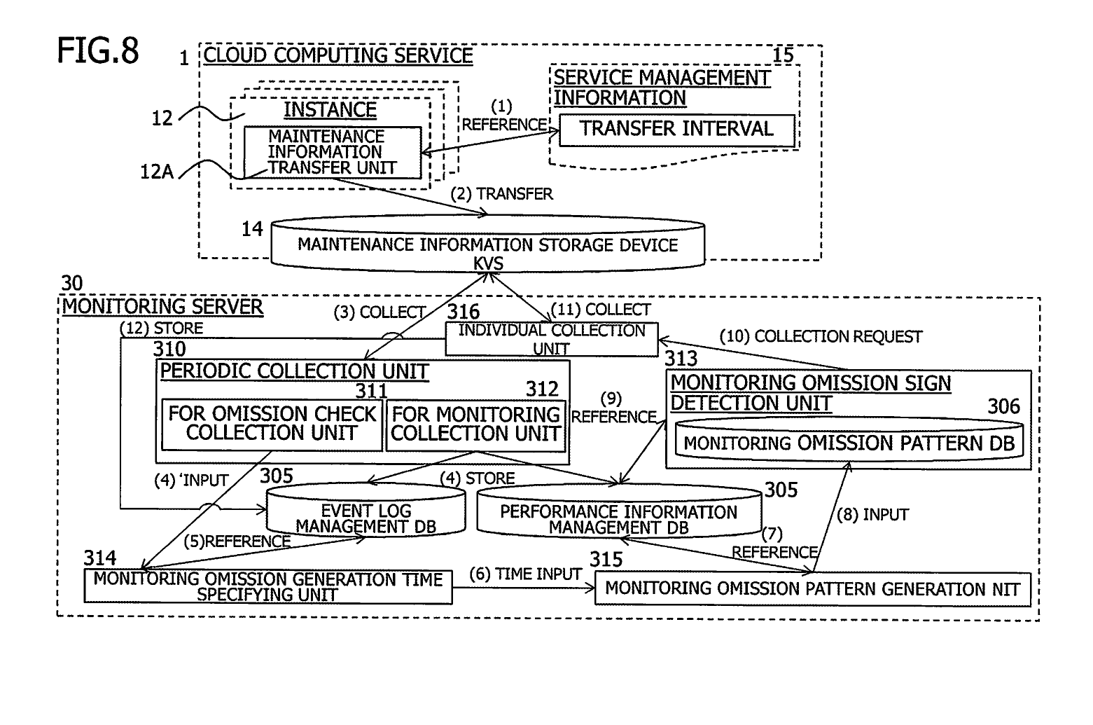

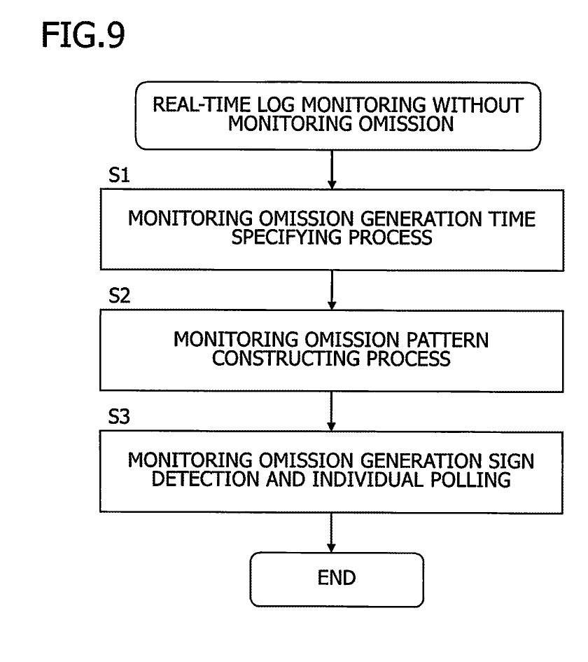

FIG. 8 is a diagram depicting a configuration and process of the cloud computing center and the monitoring server according to the present embodiment. FIG. 9 is a flow chart depicting an outline of the process of real-time log monitoring without generating a monitoring omission according to the present invention.

As illustrated in FIG. 9, as the CPU executes the monitoring program 304, the monitoring server 30 detects a monitoring omission log from the collected logs, and executes a process to specify the generation time of the transfer omission due to the transfer omission of the detected monitoring omission log (S1).

Further, as the CPU executes the monitoring program 304, the monitoring server 30 stores the transition data on the number of instances and performance information (e.g. load value) of the instances before and after the specified monitoring omission generation time, in the monitoring omission pattern DB as a monitoring omission pattern (S2).

Then as the CPU executes the monitoring program 304, the monitoring server 30 evaluates a degree of matching with the monitoring omission pattern, for the performance information collected in the polling for monitoring, detects a sign of the monitoring omission generation, and executes the individual collection polling for the instance where the sign was detected (S3).

Now the above three processes S1, S2 and S3 will be described.

It is a premise of the embodiment that in the cloud computing center 1, the maintenance information transfer unit 12A of the instance 12, constituting the service system of the user, refers to the transfer interval of the logs in the service management information 15 based on the user contract initiated by the user, and transfers a log generated in the log DB in the maintenance information storage device 14 at this transfer interval, as illustrated in FIG. 8 ((1) and (2) of FIG. 8).

[Process S1 to Specify Monitoring Omission Generation Time Due to Transfer Omission and Transfer Delay in FIG. 9]

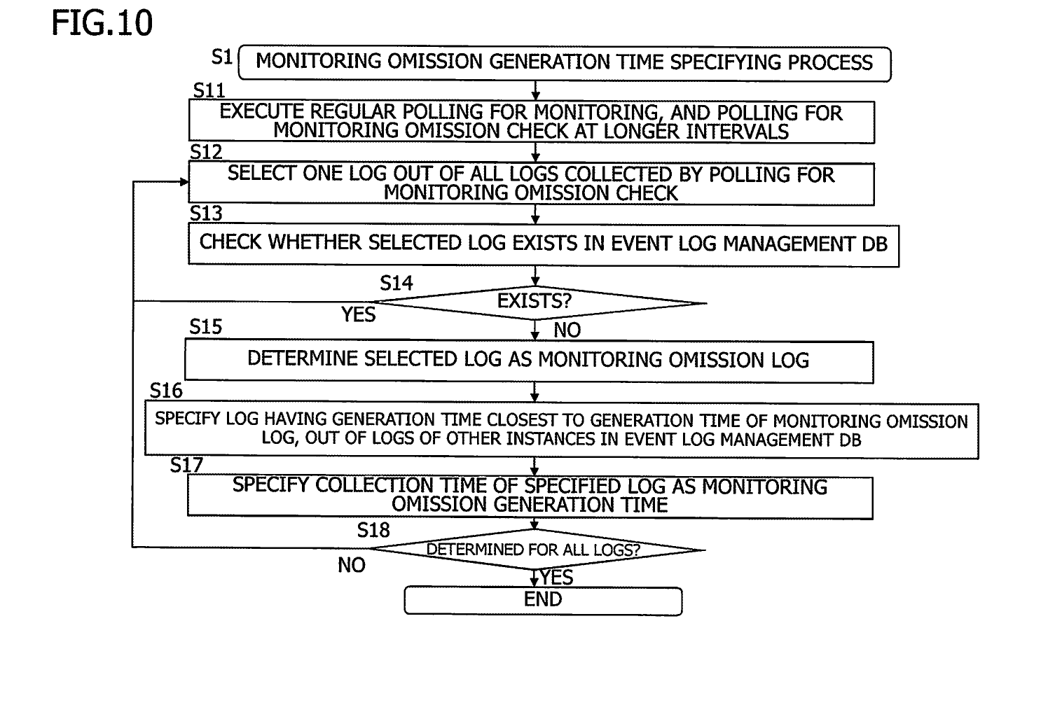

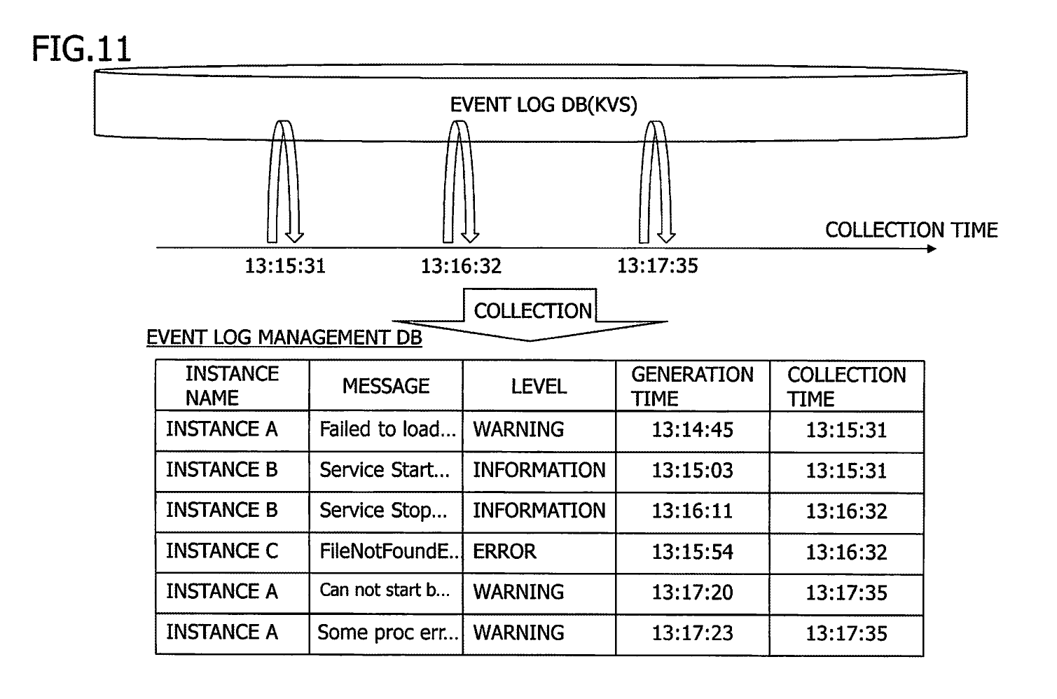

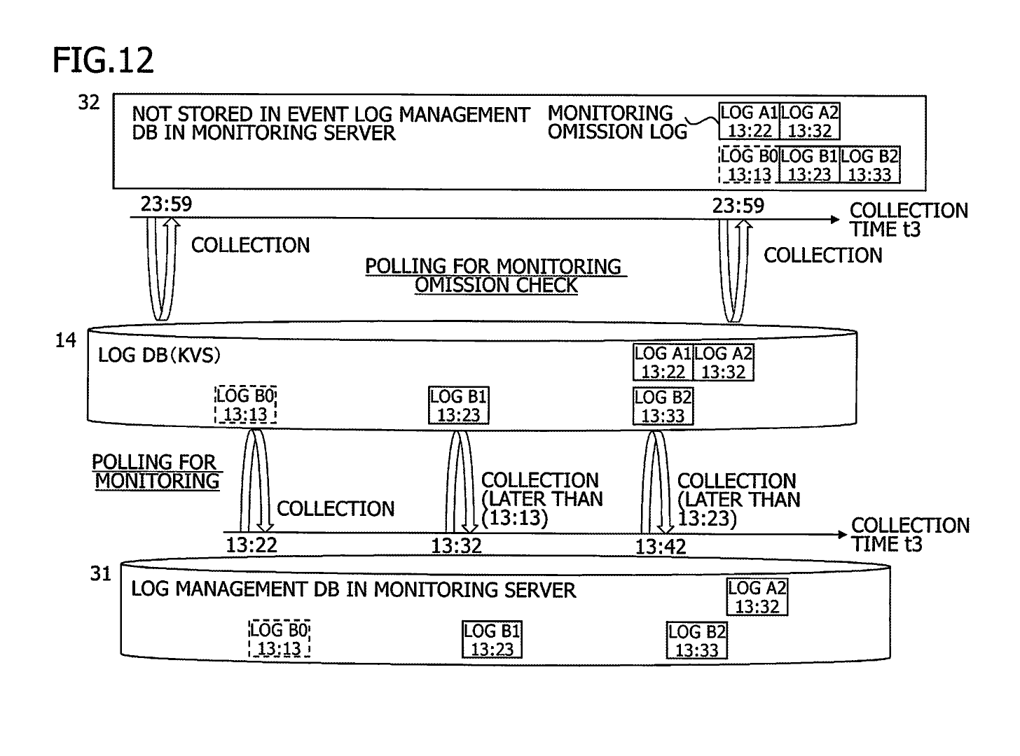

FIG. 10 is a flow chart depicting a monitoring omission generation time specifying process S1. FIG. 11 and FIG. 12 are diagrams depicting the log collection by the monitoring server.

Firstly as illustrated in FIG. 11, the monitoring server 30 executes the monitoring program, so as to store the logs collected in the polling for monitoring to the log management DB along with the collection time in the polling of collecting these logs. FIG. 11 is an example of the event log management DB. As described in FIG. 3, the log data includes a generation time of the log, event content (generation time of the event and content of the event) and the instance ID. As depicted in FIG. 11, the monitoring server 30 adds the collection time of the log to the log data, and stores the generated data in the log management DB.

In FIG. 11, the instance name corresponds to the instance ID, and the message that indicates the event content and the level that indicates the urgency level of the event correspond to the event content. In FIG. 11, each log has a generation time and a collection time. The examples of the messages listed in FIG. 11 are, in order from the top: load failure; service start notification; service stop notification; file detection disabled; startup disabled; and process error.

Secondly as illustrated in FIG. 12, when polling of a collection from the log DB in the maintenance information storage device 14 is executed, the monitoring server 30 executes the polling for a monitoring omission check, in addition to the original polling for monitoring which is executed at a first collection interval, at a second collection interval that is sufficiently longer than the first collection interval, and preferably in a time block when the load of the service is low and the number of logs to-be-generated is low. In the polling for a monitoring omission check, just like the polling for monitoring, a query is executed using a key, that is, the latest generation time of previously collected logs.

In the example in FIG. 12, the first collection interval to execute the polling for monitoring is ten minutes, and the second collection interval to execute the polling for a monitoring omission check is one day. By decreasing the frequency of the polling for a monitoring omission check like this, and preferably by performing the polling for a monitoring omission check in a time block when the service load is low, the load on the monitoring server 30 is minimized.

In the example in FIG. 12, the monitoring server 30 stores the logs collected by the polling for monitoring in the log management DB in the maintenance information storage device 31 of the monitoring server 30. However as described in FIG. 2, the log A1, of which monitoring was omitted due to the transfer omission and transfer delay, is not included in the log management DB 31 collected by the polling for monitoring. On the other hand, the log A1, of which monitoring was omitted due to the transfer delay, is included in the log 32 collected by the polling for a monitoring omission check.

The monitoring server 30 does not store logs, which are collected by the polling for a monitoring omission check, in the maintenance information storage device 31, but compares these logs with the logs collected by the polling for monitoring in the log management DB in the storage device 31, to check whether the logs match. Thereby the monitoring server 30 detects the log A1 of which monitoring was omitted due to the transfer delay. After this check, the monitoring server 30 discards the logs collected by the polling for a monitoring omission check. Thereby the capacity of the maintenance information storage device 31 is minimized.

The process S1 to specify the monitoring omission generation time, due to the transfer omission, will be described with reference to FIG. 10. As mentioned above, the monitoring server 30 executes regular polling for monitoring, and polling for a monitoring omission check is executed at a collection interval that is longer than the regular polling for monitoring, as the CPU executes the monitoring program (S11).

When the polling for a monitoring omission check is completed, the monitoring server 30 selects one log, out of all the logs collected by the polling for a monitoring omission check (32 in FIG. 12) as the CPU executes the monitoring program (S12), checks whether the selected log also exists in the event log management DB collected by the regular polling for monitoring, and discards the log after the check (S13). If the selected log also exists in the event log management DB, the monitoring server selects the next log (S12), and repeats checking whether the next log also exists in the event log management DB (S13). If the selected log does not exist in the event log management DB, then the monitoring server determines that the selected log is the monitoring omission log (S15).

Then the monitoring server 30 specifies a log having a generation time that is closest or close to the generation time of the monitoring omission log, out of the logs of instances, which are different from the instance that generated the detected monitoring omission log in the event log management DB (S16). Then the monitoring server specifies the collection time of the specified log as the monitoring omission generation time due to the transfer delay of the monitoring omission log (S17).

The monitoring server executes the processes S12 to S17 for all logs collected by the polling for a monitoring omission check, and specifies the monitoring omission generation time of all the monitoring omission logs.

The above processes will be described again with reference to FIG. 8. A monitoring collection unit 312 of a regular collection unit 310 of the monitoring server 30 executes the polling for monitoring, collects the logs in the maintenance information storage device 14, and stores the collected logs in the event log management DB and performance information management DB 305 in the maintenance information storage device 31 on the monitoring server 30 side ((3) and (4) in FIG. 8). On the other hand, a monitoring omission check collection unit 311 of the regular collection unit 310 executes the polling for a monitoring omission check, and collects the logs in the maintenance information storage device 14 ((3) and (4)′ in FIG. 8), and a monitoring omission generation time specifying unit 314 compares these logs with the logs in the event log management DB, and specifies a monitoring omission log ((5) in FIG. 8).

Now the process S16 that specifies a log having a generation time closest to the generation time of the monitoring omission log in FIG. 10 will be described in detail.

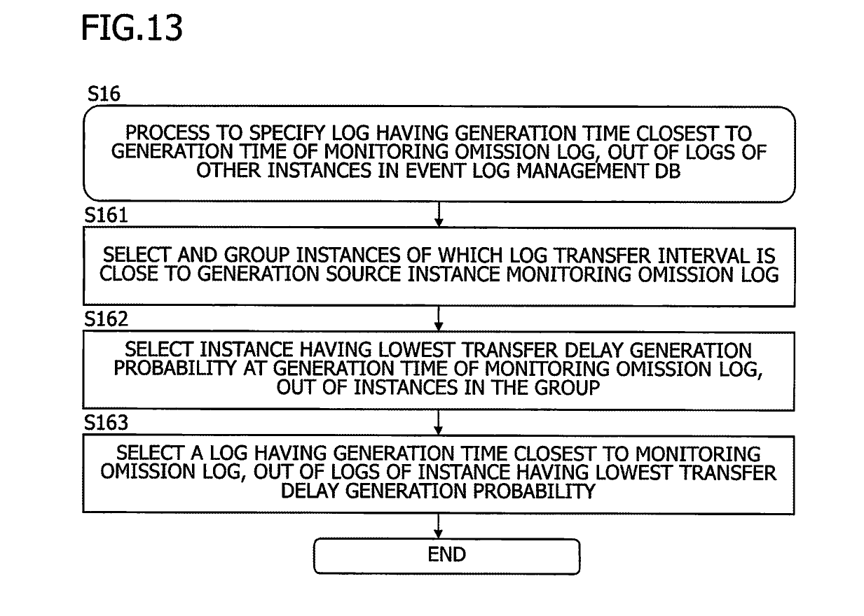

FIG. 13 is a flow chart depicting the process S16 that specifies the log having a generation time closest to the generation time of the monitoring omission log according to the present embodiment. The process S16 that specifies this log is executed by the following three processes.

It is a premise of the embodiment that the service system of the user distributes the load to a plurality of instances, hence the probability that a monitoring omission due to a transfer omission would simultaneously occur in a plurality of instances because of load concentration is low. Therefore as the monitoring omission generation time, the monitoring server estimates a collecting time of a log having a generation time closest or close to the generation time of the log of which monitoring was omitted due to a transfer omission, out of the logs of the other instances in the event log DB, of which a transfer omission did not occur.

(1) In the first of the three processes in FIG. 13, the monitoring server selects and groups instances of which log transfer interval is the same as or close to the instance that generated the monitoring omission log, out of the plurality of instances constituting the service system (S161). Here the log transfer interval of each instance is enabled to be estimated based on the time difference between the generation time and the collection time of the collected log. If the management information including the transfer interval, which the user set when the user initiated the user contract, is accessible, the set transfer interval already set may be used.

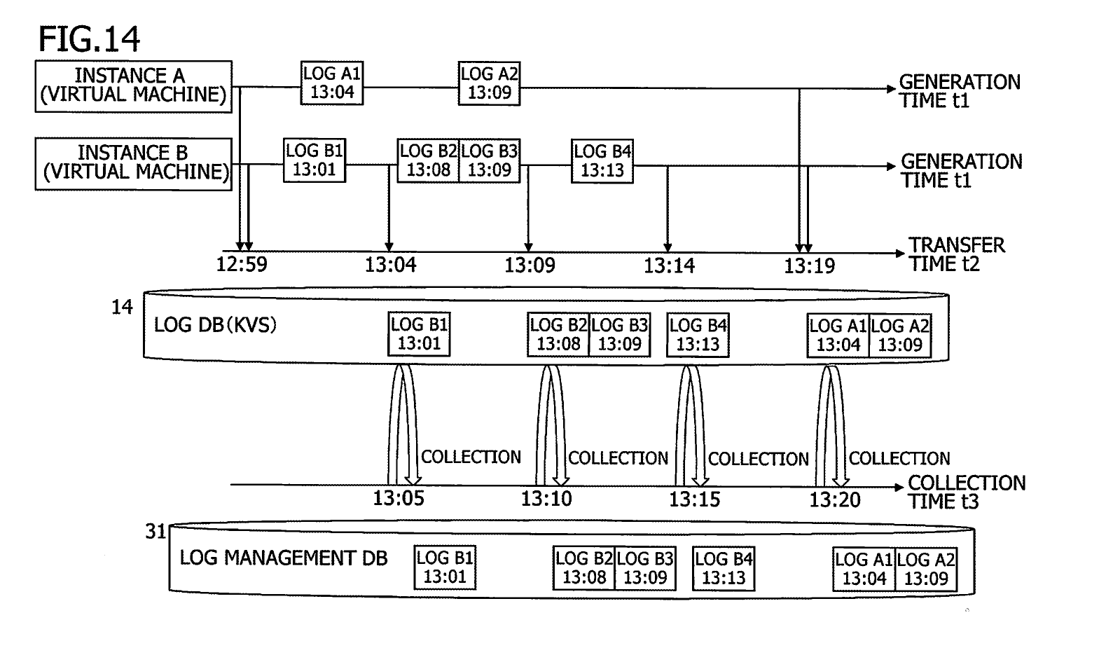

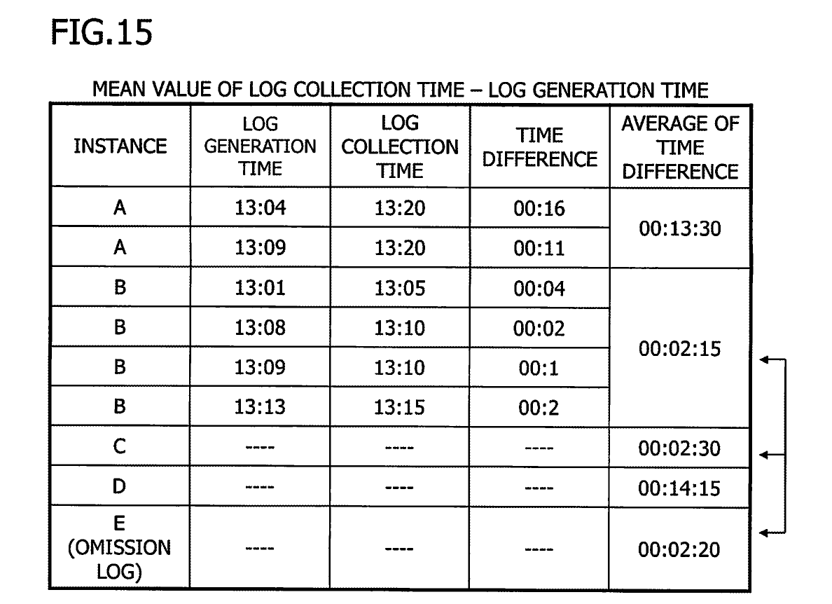

FIG. 14 and FIG. 15 is a table and a diagram respectively describing a method for estimating the log transfer interval of each instance. FIG. 14 lists the logs, generated by a plurality of instances constituting the service system, transferred to the log DB in the maintenance information storage device 14, and an example of collecting the logs in the log management DB in the maintenance information storage device 31 on the monitoring server side. The plurality of instances are, for example, instances A, B, C, D and E, but only instances A and B are listed in FIG. 14. Instances C, D and E are omitted here. Further, in this example, it is assumed that a transfer omission has not been generated in the logs of instances A and B, but that a transfer omission was generated in the log of instance E, which is not illustrated in FIG. 14.

As illustrated in FIG. 14, the instance A generated the logs A1 and A2, and transferred the logs at a relatively long transfer interval of twenty minutes. The instance B generated the logs B1 to B4, and transferred the logs at a relatively short collection interval of five minutes. The monitoring server collects the transferred logs at a relatively short collection interval of five minutes.

FIG. 15 lists an example of the time differences between the log collection time and the log generation time and a mean value thereof for each instance. The logs A1 and A2 of the instance A and the logs B1 to B3 of the instance B in FIG. 14 are also listed. The average time difference between the log collection time and the log generation time of the two logs of the instance A is 13 minutes 30 seconds, while the average time difference between the log collection time and the log generation time of the four logs of the instance B is 2 minutes 15 seconds.

When the collection interval is relatively short, the transfer interval of the logs is shorter as the time difference is shorter, and the transfer interval of the logs is longer as the time difference is longer. Therefore if an average time difference can be acquired for many logs, whether the transfer interval of each instance is the same/close or not can be determined. In the case of the examples in FIG. 15, the mean value of the time difference is close in the instances B, C and E. The monitoring server groups the instances B, C and E by comparing the mean values of the time differences like this.

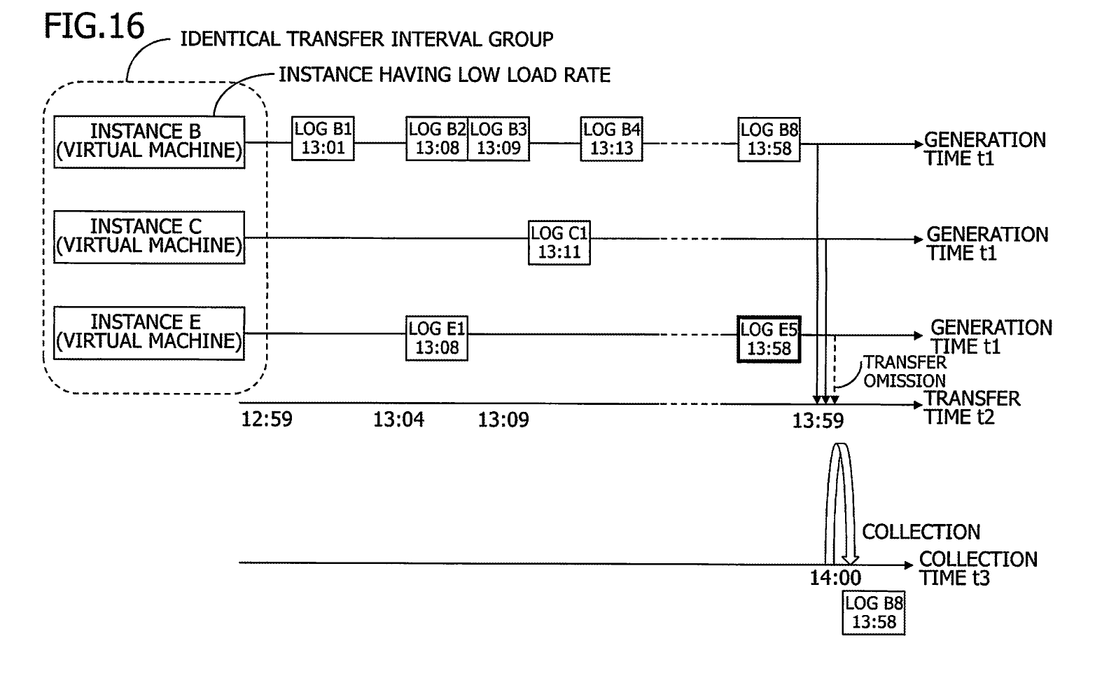

(2) In the second process of the three processes in FIG. 13, the monitoring server selects, out of the instances in the group, an instance of which the generation probability of a transfer delay, due to the transfer omission, is lowest at the generation time of the monitoring omission log (S162). This process will be described with reference to FIG. 16.

FIG. 16 is a diagram depicting an example of the logs of the instances B, C and E, which the monitoring server grouped as instances of which time differences are close. In this example, the log E5 of the instance E is the monitoring omission log due to the transfer omission. Therefore the log E5 of the instance E is the monitoring omission log, and the monitoring server selects an instance of which load value is the lowest, with reference to the load values of the instances B and C at the generation time of the log E5 13:58. In the example in FIG. 16, the instance B is selected as the instance of which load value is the lowest and which has the lowest generation probability of the transfer omission. The load value includes, for example, a CPU use rate and a memory use amount, and it can be estimated that a monitoring omission, due to the transfer omission, did not occur to an instance where these values are low.

(3) In the third out of the three processes in FIG. 13, the monitoring server selects, out of the logs of the instance of which generation probability of the transfer delay due to the transfer omission is the lowest, a log of which generation time is closest to that of the monitoring omission log (S163). In the case of the example in FIG. 16, the monitoring server selects, out of the logs of the instance B of which load is lowest and which has the lowest generation probability of the transfer delay due to the transfer omission, a log B8 that has a generation time 13:58 the same as the generation time 13:58 of the monitoring omission log E5. Thus the monitoring server is able to specify, out of the logs of the other instances of which generation probability of the transfer delay was lowest in the event log management DB in the process S16 of FIG. 10, a log B8 having a generation time closest to the generation time of the monitoring omission log E5.

Referring to FIG. 10 again, the monitoring server specifies the collection time of the log specified in the processes S16 as the monitoring omission generation time (S17). In the case of the example in FIG. 16, the monitoring server estimates the collection time 14:00 of the specified log B8 as the monitoring omission generation time due to the transfer omission of the monitoring omission log E5.

In the above mentioned first process S161 in FIG. 13, instances of which transfer interval is the same as or close to the instance of the monitoring omission log are selected and grouped, as described in FIG. 15. In this process S161, it is preferable that the monitoring server selects, as the instance of which transfer interval is the same or close, an instance of which transfer interval is as short as the instance of the monitoring omission log. In other words, the reason why the monitoring omission generation time is specified by detecting the monitoring omission log is because the urgency and real-time properties of the log collection of this instance are high. Generally a short transfer interval is set for an instance of which urgency of log collection is high. This is because in some cases it may take a long time from log generation to log collection if the transfer interval is long.

The instance of which monitoring omission generation time is specified has a sufficiently short transfer interval, hence an instance of which transfer interval is close to the instance where transfer omission was generated in the process S161 refers to an instance having an equivalent short transfer distance after eliminating instances of which transfer interval is long.

The monitoring omission generation time specifying process S1 in FIG. 9 has thus completed. In the example in FIG. 2, if the log A1 is the monitoring omission log, and if an instance, of which transfer interval is close to the instance A and of which load was the lightest at the generation time of the monitoring omission log A1, that is 13:22, is the instance B, then the generation time of the log B1 of this instance is close to the generation time of the monitoring omission log A1. As a consequence, the collection time 13:32 of the log B1 is estimated as the time when the monitoring omission was generated due to the transfer omission of the log A1.

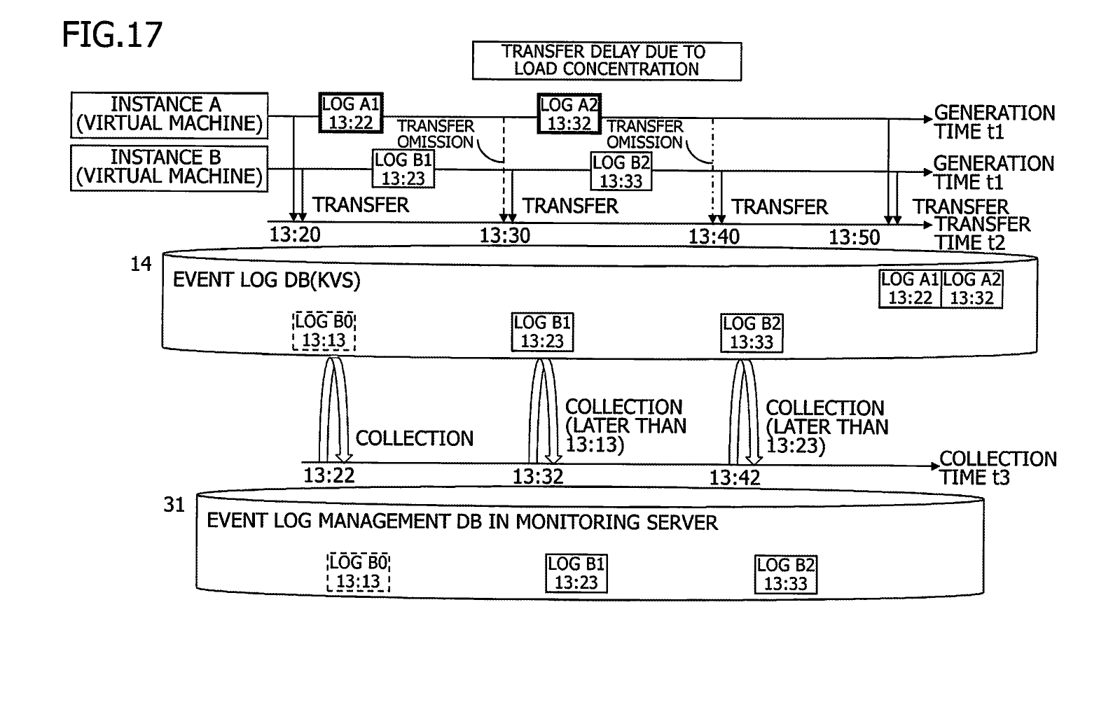

FIG. 17 is a diagram depicting an example of the monitoring omission generation time specified in the monitoring omission generation time specifying process S1. The logs A1, A2, B1 and B2 generated by the instances A and B in FIG. 17 are the same as the examples in FIG. 2. However unlike FIG. 2, the transfer delay due to load concentration is generated in the instance A at the transfer times 13:30 and 13:40. In this case, in the monitoring omission generation time specifying process S1, the monitoring server estimates that the monitoring omission generation time of the monitoring omission log A1 is the collection time of the log B1, that is 13:32, and estimates that the monitoring omission generation time of the monitoring omission log A2 is the collection time of the log B2, that is 13:40. As a result, the monitoring server estimates the monitoring omission generation time block as the time between 13:32 and 13:42.

[Monitoring Omission Pattern Constructing Process S2 in FIG. 9]

As the CPU executes the monitoring program 304, the monitoring server 30 stores the transition data on the number of instances and the performance information (e.g. load value) of each instance before and after the specified monitoring omission generation time in the monitoring omission pattern DB as the monitoring omission pattern (S2).

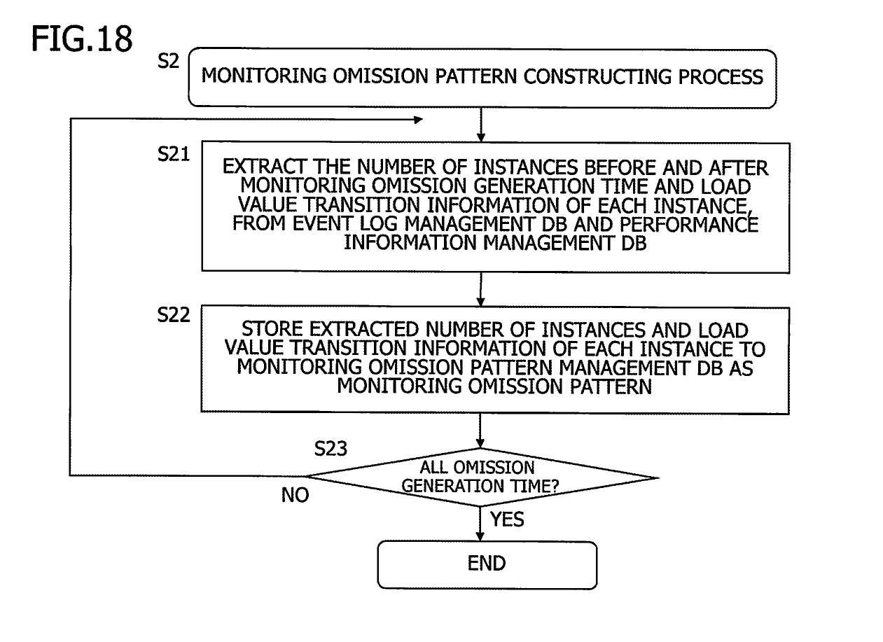

FIG. 18 is a flow chart depicting the monitoring omission pattern constructing process S2. As the CPU executes the monitoring program, the monitoring server extracts the transition information on the number of instances of the service system the load value of each instance before and after the monitoring omission generation time from the event log management DB and the performance information management DB (S21). Then the monitoring server stores the transition information on the extracted number of instances and the load value of each instance in the monitoring omission pattern DB as the monitoring omission pattern (S22).

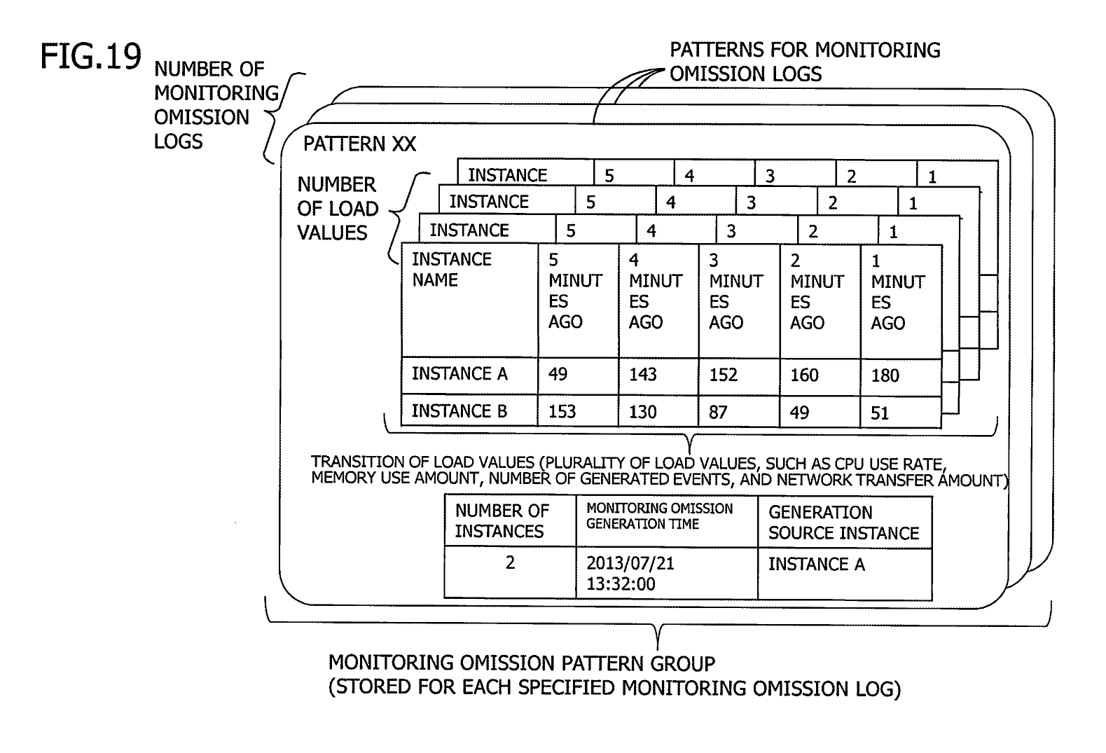

FIG. 19 is a diagram depicting an example of the monitoring omission pattern. The monitoring server stores a monitoring omission pattern in the monitoring omission pattern DB for each monitoring omission log. The example of the monitoring omission pattern in FIG. 18 has “2” instances, that is the instances A and B constituting the service system, the monitoring omission generation time, a generation source instance “A” which generated the monitoring omission log, and the transition data of the load values of the instances A and B for five minutes before the monitoring omission generation time. There are, for example, four types of load values: a CPU use rate, a memory use amount, the number of generated events, and a network transfer amount, and one of the load values is indicated in FIG. 19. According to the example in FIG. 19, the load value of the instance A rapidly increased, but the load value of the instance B decreased.

The monitoring server has thus completed the monitoring omission pattern constructing process S2 in FIG. 9. Describing this process again with reference to FIG. 8, the monitoring omission pattern generation unit 315 of the monitoring server 30 extracts the performance information management DB before and after the monitoring omission generation time based on the monitoring omission generation time specified by the monitoring omission generation time specifying unit 314 (see (6) in FIG. 8), generates the monitoring omission pattern, and stores the monitoring omission pattern in the monitoring omission pattern DB 306 ((8) in FIG. 8).

Then using the monitoring omission patterns generated by analyzing the logs collected in the past, the monitoring server detects a sign of the monitoring omission generation while monitoring the degree of matching with the monitoring omission pattern for the transition of the performance information of the instances of the monitoring target service system in the future. This is the sign detection of monitoring omission generation and the individual polling process S3 in FIG. 9.

[Detection of Sign of Monitoring Omission Generation and Individual Polling Process S3 in FIG. 9]

The monitoring server detects the sign based on the monitoring omission pattern as the CPU executes the monitoring program. In other words, at each timing when a polling for monitoring ended, the monitoring server finds the degree of matching of the transition pattern of the load value from a predetermined time before to a latest time, and the monitoring omission pattern in the monitoring omission pattern DB. And the monitoring server detects a sign of the monitoring omission generation in an instance which has a pattern matching with the pattern of the instance that generated the monitoring omission log in the monitoring omission pattern with high degree of matching.

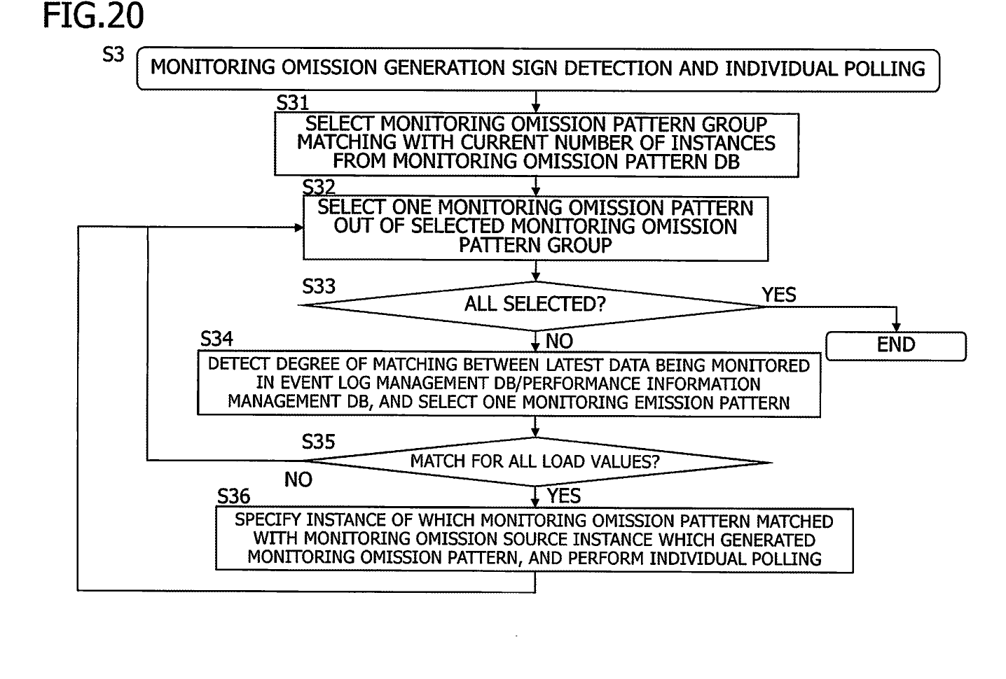

FIG. 20 is a flow chart depicting the sign detection of the monitoring omission generation and the individual polling process S3 in FIG. 9. The monitoring server continuously collects the event logs and the performance information logs of the instances constituting the monitoring target service system. Then the monitoring server executes the process in FIG. 20 at a timing when the monitoring polling ends each time.

First the monitoring server selects a monitoring omission pattern group of which the number of instances matches with the number of instances of the currently monitoring service system out of the monitoring omission pattern DB (S31). In some cases the generation of a monitoring omission depends on the number of instances of the service system, hence it is preferable to narrow the comparison target monitoring omission pattern group down based on the number of instances. Even if the number of instances do not match, a close number of monitoring omission patterns having a close number of instances may be selected.

Then the monitoring server selects one monitoring omission pattern out of the selected monitoring omission pattern group (S32). If the monitoring omission pattern to-be-selected exists (NO in S33), the monitoring server detects the degree of matching between the selected monitoring omission pattern and the latest data currently being monitored in the event log management DB and the performance information management DB, that is, the latest data of the load value of each instance (S34). In other words, the degree of matching between the transition data of the latest load value and the transition data of the load value in the monitoring omission pattern is detected by a known degree of matching calculation method. Therefore in order to collect the latest data of the load value of each instance, it is preferable to transfer and collect the performance information logs at relatively short intervals.

Then the monitoring server checks whether the transition data of the load values of all the instances of the selected monitoring omission pattern match with the transition data of the latest load values of all the instances of the service system currently being monitored (S35). In this check, if there are three types of load values, the load values need to be match for the respective types. If it is detected that the transition data of all the instances match for all the load values (YES in S35), the monitoring server specifies an instance of which transition data matches with the monitoring omission source instance of the monitoring omission pattern, and executes the individual polling for the instance (S36). The processes S32 to S36 are executed for all the patterns of the selected monitoring omission pattern group, and the processes end (YES in S33).

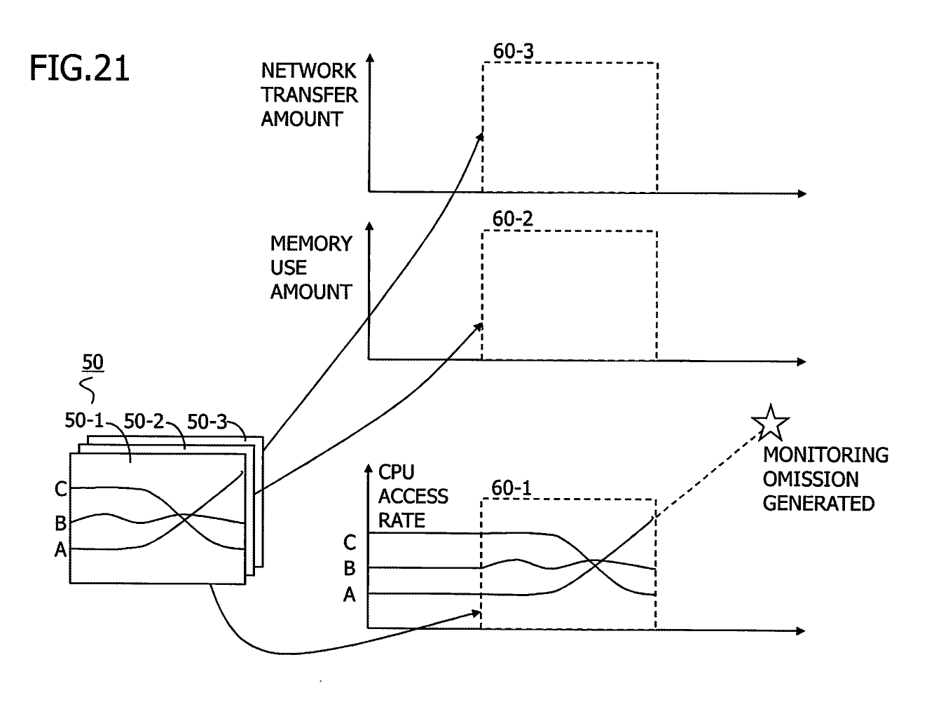

FIG. 21 is a diagram depicting the match between the monitoring omission pattern and the transition data of a load value currently being monitored in the sign detection of monitoring omission generation. In FIG. 21, one monitoring omission pattern 50 selected from the monitoring omission pattern group in the process S32 has the transition data of three load values, 50-1, 50-2 and 50-3, and each of which has the transition data of the load values of the three instances, A, B and C. The transition data of the load value 60 of the service system currently being monitored also has the transition data of three load values, 60-1, 60-2 and 60-3, each of which has the transition data of the load values of the three instances, A, B and C. In the example in FIG. 21, the load values are: the CPU use rate, the memory use amount and the network transfer amount.

The monitoring server detects the degree of matching between the monitoring omission pattern 50-1 on one load value of the monitoring omission pattern 50 and the transition data of the same load value 60-1 currently being monitored. In the example in FIG. 21, the monitoring omission pattern 50-1 and the transition data of the load value 60-1 currently being monitored match. In the same way, the monitoring server detects the degree of matching between the monitoring omission patterns 50-2 and 50-3 and the transition data of the load values 60-2 and 60-3 currently being monitored respectively. Then the sign of monitoring omission generation is detected when the degree of matching is high (perfect match) for all three load values. The above description corresponds to the processes S32 to S35 in FIG. 20.

When the sign of the monitoring omission generation is detected, the monitoring server specifies an instance of which transition data matched with the monitoring omission source instance of the monitoring omission pattern, and performs individual polling for the specified instance.

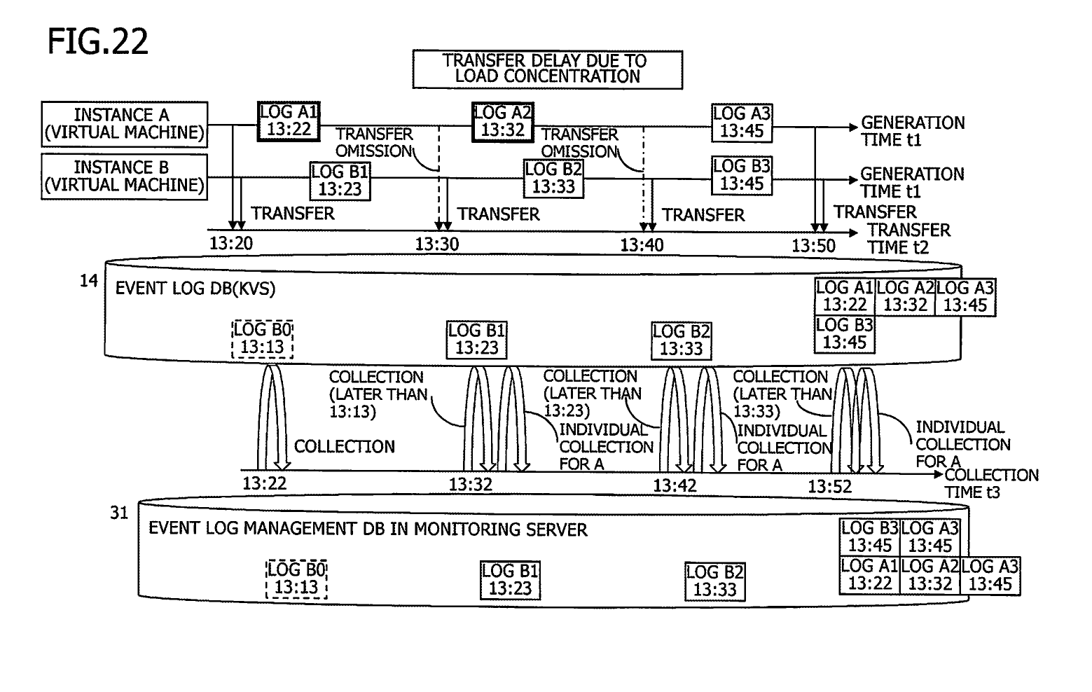

FIG. 22 is a diagram depicting the individual collection when the sign of monitoring omission generation is detected according to this embodiment. The instances A and B in FIG. 22 generate logs A1, A2 and A3 and logs B1, B2 and B3 respectively, and the instance A generated the transfer omission at times 13:30 and 13:40 due to load concentration thereby causing a transfer delay. The example in FIG. 22 is the same as the example in FIG. 17, except that the logs A3 and B3 are generated. And in the example in FIG. 22, the instance A executes the transfer at time 13:50. As a result, the illustrated log has been transferred to the log DB in the maintenance information storage device 14.

FIG. 22 is an example when the monitoring server detects a sign of the monitoring omission generation in the instance A, and the monitoring server executes the polling of individual collection for the instance A at the collection times 13:32, 13:42 and 13:52. As a result, the monitoring server is not able to collect the log of the instance A at the collection times 13:32 and 13:42, but redundantly collects the log A3 by batch collection and individual collection, and collects the logs A1 and A3, of which transfer delayed, by the individual collection for the instance A at the collection time 13:52. At the collection time 13:52, the managing server collected the logs A1 and A2, which were generated before the previous collection time, therefore the monitoring server stops the individual collection for the instance A, and collects the logs only by regular monitoring polling at the next and subsequent collection times.

Describing this process again with reference to FIG. 8, the monitoring omission sign detection unit 313 of the monitoring server 30 monitors the degree of matching between the monitoring omission pattern 306 and the transition data of the performance data in the performance information management DB 305 ((9) in FIG. 8), and if a sign of monitoring omission is detected, the individual collection unit 316 of the monitoring server 30 executes the individual collection for this instance ((10) and (11) in FIG. 8). The logs of which transfer delayed due to the transfer omission can be collected by this individual collection.

As described above, according to this embodiment, the monitoring omission generation time is accurately estimated based on the collected logs. As a result, by comparing the transition data of the performance information of the instances constituting the service system before and after the monitoring omission generation time with the monitoring omission pattern, a sign of monitoring omission generation in an instance of the service system currently being monitored is detected. And individual polling is executed for the instance in which the sign is detected, whereby the logs of which transfer delayed is collected virtually in real-time.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a monitoring omission specifying program for causing a computer to execute a process comprising:
collecting log items respectively including generation time of events, which are transferred from a plurality of monitored devices to a first log item storage device, from the first log item storage device, and storing the collected log items in a second log item storage device, along with information on collection times when the collected log items are collected;
detecting a monitoring omission log item, of which a transfer delay to the first log item storage device has occurred, out of log items in the second log item storage device; and
specifying, as a generation time of the transfer delay of the monitoring omission log item, a collection time of a log item generated by another monitored device, which is different from the monitored device that has generated the monitoring omission log item, and having a generation time close to the generation time of the monitoring omission log item.

2. The non-transitory computer-readable storage medium storing therein the monitoring omission specifying program according to claim 1, wherein
the specifying the generation time of the transfer delay includes:
grouping a first monitored devices that have transfer intervals equal or close to the transfer interval of the monitored device that has generated the monitoring omission log item; and
detecting the log item of the other monitored device from log items of the grouped first monitored devices.

3. The non-transitory computer-readable storage medium storing therein the monitoring omission specifying program according to claim 1, wherein
the specifying the generation time of the transfer delay includes:
grouping a first monitored devices that have transfer intervals equal or close to the transfer interval of the monitored device that has generated the monitoring omission log item;
selecting a second monitored device of which generation probability of transfer delay at the generation time of the monitoring omission log item is lowest, out of the grouped first monitored devices; and
detecting the log item of the other monitored device from log items of the selected second monitored device.

4. The non-transitory computer-readable storage medium storing therein the monitoring omission specifying program according to claim 1, wherein
the storing the log items in the second log item storage device includes:
collecting the log items, which are transferred to the first log item storage device, at a first collection interval; and
collecting the log items, which are transferred to the first log item storage device, at a second collection interval which is longer than the first collection interval, and
the detecting the monitoring omission log items includes:
detecting a log item, which does not exist in a first log item group collected at the first collection interval, and exists in a second log item group collected at the second collection interval, as the monitoring omission log.

5. The non-transitory computer-readable storage medium storing therein the monitoring omission specifying program according to claim 1, wherein
the process further comprises:
extracting, from the collected log items, transition information of a load value of the monitored device that has generated the monitoring omission log, in a time block until the specified generation time of the transfer delay, and storing the extracted transition information of the load value as a monitoring omission pattern;
monitoring whether transition information of a load value of a monitored device currently being monitored matches with the transition information of the load value of the monitoring omission pattern; and
detecting a sign of generation of monitoring omission in a monitored device of which the transition information matches with the monitoring omission pattern.

6. The non-transitory computer-readable storage medium storing therein the monitoring omission specifying program according to claim 5, wherein
a service system is constituted by the monitored devices,
the monitoring omission pattern includes the number of monitored devices constituting the service system, in addition to the transition information of the load value, and
the monitoring whether the transition information matches with the monitoring omission pattern includes:
determining whether the number of monitored devices constituting the service system currently being monitored matches with the number of monitored devices of the monitoring omission pattern, and executing the monitoring process for a monitoring omission pattern of which the number of monitored devices matches.

7. A monitoring omission specifying method comprising:
collecting log items respectively including generation time of events, which are transferred from a plurality of monitored devices to a first log item storage device, from the first log item storage device, and storing the collected log items in a second log item storage device, along with information on collection times when the collected log items are collected;
detecting a monitoring omission log item, of which a transfer delay to the first log item storage device has occurred, out of log items in the second log item storage device; and
specifying, as a generation time of the transfer delay of the monitoring omission log item, a collection time of a log item generated by another monitored device, which is different from the monitored device that has generated the monitoring omission log item, and having a generation time close to the generation time of the monitoring omission log item.

8. A monitoring omission specifying device comprising:
a processor; and
a memory storing therein a monitoring omission specifying program for causing a processor to execute a process including,
collecting log items respectively including generation time of events, which are transferred from a plurality of monitored devices to a first log item storage device, from the first log item storage device, and stores the collected log items in a second log item storage device, along with information on collection times when the collected log items are collected;
detecting a monitoring omission log item, of which a transfer delay to the first log item storage device has occurred, out of log items in the second log item storage device; and
specifying, as a generation time of the transfer delay of the monitoring omission log item, a collection time of a log item generated by another monitored device, which is different from the monitored device that has generated the monitoring omission log item, and having a generation time close to the generation time of the monitoring omission log item.
